(19) United States
(12) Patent Application Publication
(10) Pub. No.: US 2017/0174840 A1
(43) Pub. Date: Jun. 22, 2017

(54) MOISTURE CURABLE SILICONE COMPOSITION

(71) Applicant: Momentive Performance Materials Inc., Waterford, NY (US)

(72) Inventor: Sumi Dinkar, Bangalore (IN)

(21) Appl. No.: 15/115,927

(22) PCT Filed: Feb. 3, 2015
(86) PCT No.: PCT/US15/14160

§ 371 Date: Aug. 2, 2016

Related U.S. Application Data
(60) Provisional application No. 61/936,462, filed on Feb. 6, 2014.

(51) Int. Cl. C08G 77/08; C09D 183/10; B01J 23/10

(52) U.S. Cl. CPC C08G 77/08; B01J 23/10; C09D 183/10

(57) ABSTRACT

The present invention provides curable compositions comprising (A) an polymer having a reactive silicon-containing group, (B) a cross-linker and/or a chain extender, (C) a non-tin metal catalyst, (D) an adhesion promoter, (E) optionally a filler, (F) optionally cure accelerator. The above curable compositions exhibit excellent adhesiveness, deep section cure, stable curability even after storage and/or retained physical properties even after subjecting to the accelerated humidity and temperatures.

### CROSS REFERENCE TO RELATED APPLICATIONS

The present application claims priority to and the benefit of U.S. Provisional Application No. 61/936,462 filed on Feb. 6, 2014 and titled “Moisture Curable Composition,” the disclosure of which is incorporated herein by reference in its entirety.

### FIELD

The present invention relates to room temperature curable containing a polymer which has a hydrolysable group bonded to silicon atom and has a group having silicon that can be crosslinked through formation of a siloxane bond. In particular, the present invention provides curable compositions that exhibit good curability, adhesiveness, excellent hardness, and/or are storage stable, and which contain an organo-tin free metal complex catalyst, such as yttrium, gallium, scandium, and tantalum complexes.

### BACKGROUND

Polymers having reactive terminal silyl groups or compositions comprising such polymers can be hydrolyzed and condensed in the presence of water and metal catalysts. Suitable known catalysts for curable compositions include compounds employing metals such as Sn, Ti, Zn, or Ca. Organotin compounds such as, for example, dibutyltin-dilaurate (DBTDL) are widely used as condensation cure catalysts to accelerate the moisture-assisted curing of a number of different polyorganosiloxanes and non-silicone polymers having reactive terminal silyl groups such as room temperature vulcanizing (RTV) formulations including RTV-1 and RTV-2 formulations. Environmental regulatory agencies and directives, however, have increased or are expected to increase restrictions on the use of organotin compounds in formulated products. For example, while formulations with greater than 0.5 wt. % dibutyltin presently require labeling as toxic with reproductive 1B classification, dibutyltin-containing formulations are proposed to be completely phased out in consumer applications during the next one or two years.

The cure chemistry of these moisture-curable compositions can vary based upon the nature of the polymers and their moisture-curable groups. For example, alkoxysilyl groups first hydrolyze to give silanol functionalities, which then condense with the extrusion of water to give the siloxane network. Such compositions typically comprise an alkoxysilyl- or silanol-functional polymer and a crosslinking agent. Tri- and tetraalkoxysilanes are commonly used as crosslinking agents and will react with water or directly with silanol groups to crosslink the system. However, for compositions comprising hydridosilyl groups or both hydridosilyl and silanol functionalities, such a crosslinking agent is not required. In fact, due to the multitude of hydridosilyl groups present, the hydridosilyl-containing compound is often referred to as the crosslinking agent. In these compositions, hydridosilyl groups may react with water to give silanol functionalities or they may react directly with silanol groups to form siloxane bonds with extrusion of hydrogen gas. For transition-metal-catalyzed compositions comprising a hydridosilyl-containing compound, inhibitors are commonly used to ensure adequate shelf life or pot life.

Substitutes for organotin catalysts should exhibit properties similar to organotin compounds in terms of curing, storage, and appearance. Non-tin accelerators would also desirably initiate the condensation reaction of the selected polymers and complete this reaction upon the surface and may be in the bulk in a desired time schedule. There are therefore many proposals for the replacement of organometallic tin compounds with other metal- and non-metal-based compounds. These new accelerators have specific advantages and disadvantages in view of replacing tin compounds perfectly. Therefore, there is still a need to address the weaknesses of possible non-tin compounds as suitable accelerators for condensation cure reactions. The physical properties of uncured and cured compositions also warrant examination, in particular to maintain the ability to adhere onto the surface of several substrates.

Generally, there has not been a replacement catalyst for organotin compounds that maintains its ability to cure when exposed to humidity or ambient air after storage over months in a sealed cartridge. It is always a specific requirement for moisture-curable compositions to achieve the shortest possible curing times, showing a tack-free surface as well as curing through the complete bulk in thick section for RTV-1 and RTV-2 compositions. Additionally, such compositions should provide a good adhesion after cure onto a variety of substrates, including difficult to adhere substrates like plastics. Thus, there is still a need for alternative materials to replace organotin as a cure accelerator in moisture curable compositions. More importantly, cured articles obtained from curable compositions each including any of the organic polymers and siloxane polymers and an organotin catalyst are often poor in heat resistance, and the physical properties of cured articles are largely degraded by heating. Siloxane polymers are more susceptible to degradation than organic polymers due to the Si—O—Si back bone compared to the carbon bond linkages of organic polymers.

### SUMMARY

The present invention provides, in one aspect, tin-free, curable compositions that comprise silyl-terminated curable polymers and an organo-tin free catalyst based on metal-containing complexes. The present invention provides a curable composition that has good curability, adhesiveness, excellent hardness and/or is storage stable containing an organo-tin free metal complexes, such as yttrium, gallium, scandium and tantalum complexes as condensation cure accelerators.

In one aspect, the present invention provides a polymer composition that can be used both in crosslinking single component and two component elastomer compositions.

In another aspect, the present invention provides a polymer composition that continues to simultaneously meet the constraints of storage of processing and crosslinking of single component and two component compositions.

In still another aspect, the present invention provides a polymer composition having excellent hardness while still providing good adhesiveness to various substrates including difficult to adhere to substrates, such as, for example, PBT and other plastic substrates along with metal and glass substrates.

In yet another aspect, the present invention provides a polymer composition that exhibits retained mechanical integrity of the cured article even after accelerated heat aging processes.

In one embodiment, the curable composition comprises (A) an polymer having a reactive silicon-containing group, (B) a cross-linker; a chain extender; and extender; or a combination of two or more thereof, (C) a non-tin metal catalyst, (D) an adhesion promoter, (E) optionally containing fillers, and (G) optionally cure accelerator, wherein the non-tin metal catalyst comprises a metal chosen from yttrium, gallium, scandium and/or tantalum. In one embodiment, the catalyst comprise a compound of the formula:

M^{III}L_{3-c}A_{c} (6)

wherein M is a metal chosen from yttrium, gallium, scandium and/or tantalum; L is a chelating ligand; A is an anion; and c is 0 to 3 or an integer.

In one embodiment, L is chosen from a diketonate, a diamine, a triamine, an aminoacetate, a nitriloaceate, a bipyridine, a glyoxime, a carboxylate, an acetate, or a combination of two or more thereof.

In one embodiment, the L is chosen from a monocarboxylic acid or a carboxylic acid containing at least two carbon atoms. In one embodiment, the chelating agent L can be a carboxylic acid of the formula R⁹COO—; wherein R⁹ is a linear or branched C₁-C₃₀ alkyl group, a C₆-C₁₀ cyclic group, or a C₆-C₁₀ aromatic group. In one embodiment, R⁹ is a linear or branched C₁₀-C₃₀ alkyl group.

In one embodiment, the anion A is chosen from a halide, hydroxide, oxide, peroxide, ozonide, hydrosulfide, alkoxides, alkyl thio, nitride, acetate, amide, carboxylate, cyanide, cyanate, thiocyanate, carbonate, hydrogen carbonate, or a combination of two or more thereof.

In one embodiment, the anion A is chosen from F—, Cl—, (I₃)—, [ClF₂]—, [IF₆]—, (ClO)—, (ClO₂)—, (ClO₃)—, (ClO₄)—, (OH)—, (SH)—, (SeH)—, (O₂)—, (O₃)—, (HS₂)—, (CH₃O)—, (C₂H₅O)—, (C₃H₇O)—, (CH₃S)—, (C₂H₅S)—, (C₂H₄CIO)—, (C₆H₅O)—, (C₆H₅S)—, [C₆H₄(NO₂)O]—, (HCO₂)—, (C₇H₁₅CO₂)—, (CH₃CO₂)—, (CH₃CH₂CO₂)—, (N₃)—, (CN)—, (NCO)—, (NCS)—, (NCSe)—, (NH₂)—, (PH₂)—, (ClHN)—, (Cl₂N)—, (CH₃NH)—, (HN═N)″, (H₂N—NH)—, (HP═P)—, (H₂PO)—, (H₂PO₂)—, or a combination of two or more.

In one embodiment, the metal-containing compound comprises a yttrium carboxylate, e.g., yttrium neodecanoate.

In one embodiment, the metal-containing compound comprises gallium triflate.

In one embodiment, the composition comprises about 0.0001 to 10 parts per weight of catalyst (C) per 100 parts per weight of the polymer (A). In one embodiment, the composition comprises from about 0.005 to 0.05 parts per weight of catalyst (C) per 100 parts per weight of the polymer (A). In one embodiment, the composition comprises from about 0.01 to 5 parts per weight of catalyst (C) per 100 parts per weight of the polymer (A). In one embodiment, the composition comprises from about 0.05 to about 0.4 parts per weight of catalyst (C) per 100 parts per weight of the polymer (A). In one embodiment, the composition comprises from about 0.1 to 1 parts per weight of catalyst (C) per 100 parts per weight of the polymer (A).

In one embodiment, the catalyst (C) is substantially free of tin.

In one embodiment, the crosslinker or chain extender is chosen from an alkoxysilane, an alkoxysiloxane, an oximosilane, an oximosiloxane, an enoxysilane, an enoxysiloxane, an aminosilane, an aminosiloxane, a carboxysilane, a carboxysiloxane, an alkylamidosilane, an alkylamidosiloxane, an arylamidosilane, an arylamidosiloxane, an alkoxyaminosilane, an alklarylaminosiloxane, an alkoxycarbamatosilane, an alkoxycarbamatosiloxane, and combinations of two or more thereof.

In one embodiment, the polymer (A) has the formula (1):

[R¹ₐR²₃₋ₐSi—Z—]ₙ—X—Z—SiR¹ₐR²₃₋ₐ (1)

where X is chosen from a polyurethane; a polyester; a polyether; a polycarbonate; a polyolefin; a polyesterether; and a polyorganosiloxane having units of R₃SiO_{1/2}, R₂SiO, RSiO_{3/2}, and/or SiO₂; n is 0 to 100; a is 0 to 2; R and R¹ can be identical or different at the same Si-atom and chosen from a C₁-C₁₀ alkyl; a C₁-C₁₀ alkyl substituted with one or more of Cl, F, N, O or S; a phenyl; a C₇-C₁₆ alkylaryl; a C₇-C₁₆ arylalkyl; a C₂-C₄ polyalkylene ether; or a combination of two or more thereof; R² is chosen from OH, C₁-C₈ alkoxy, C₂-C₁₈ alkoxyalkyl, oximoalkyl, enoxyalkyl, aminoalkyl, carboxyalkyl, amidoalkyl, amidoaryl, carbamatoalkyl, or a combination of two or more thereof; and Z is a bond, a divalent unit selected from the group of a C₁-C₈ alkylene, or 0.

In one embodiment, the polymer component (A) has the formula (3):

R²_{3-c-d}SiR³_{c}R⁴_{d}—[OSiR³R⁴]ₓ—[OSiR³R⁴]_{y}—OSiR³ₑR⁴_{f}R²_{3-e-f} (3)

where x is 0 to 10000; y is 0 to 1000; c, d, and f are independently chosen from 0 to 2; R¹ is chosen from a C₁-C₁₀ alkyl; a C₁-C₁₀ alkyl substituted with one or more of Cl, F, N, O, or S; a phenyl; a C₇-C₁₆ alkylaryl; a C₇-C₁₆ arylalkyl; a C₂-C₄ polyalkylene ether; or a combination of two or more thereof, and other siloxane units may be present in amounts less than 10 mol. % preferably methyl, vinyl, phenyl; R² is chosen from OH, a C₁-C₈ alkoxy, a C₂-C₁₈ alkoxyalkyl, an oximoalkyl, an oximoaryl, an enoxyalkyl, an enoxyaryl, an aminoalkyl, an aminoaryl, a carboxyalkyl, a carboxyaryl, an amidoalkyl, an amidoaryl, a carbamatoalkyl, a carbamatoaryl, or a combination of two or more thereof; and Z is —O—, a bond, or —C₂H₄—; and R³ and R⁴ can be identical or different on the same silicon atom and are chosen from hydrogen; C₁-C₁₀ alkyl; C₁-C₁₀ heteroalkyl, C₃-C₁₂ cycloalkyl; C₂-C₃₀ heterocycloalkyl; C₆-C₁₃ aryl; C₇-C₃₀ alkylaryl; C₇-C₃₀ arylalkyl; C₄-C₁₂ heteroaryl; C₅-C₃₀ heteroarylalkyl; C₅-C₃₀ heteroalkylaryl; C₂-C₁₀ polyalkylene ether; or a combination of two or more thereof.

In one embodiment, the polymer (A) is chosen from silylated polyurethane (SPUR), silylated polyester, silylated polyether, silylated polycarbonate, silylated polyolefins like polyethylene, polypropylene, silylated polyesterether, and combinations of two or more thereof.

In one embodiment, the crosslinker component (B) is chosen from tetraethylorthosilicate (TEOS); methyltrimethoxysilane (MTMS); methyltriethoxysilane; vinyltrimethoxysilane; vinyltriethoxysilane; methylphenyldimethoxysilane; 3,3,3-trifluoropropyltrimethoxysilane; methyltriacetoxysilane; vinyltriacetoxysilane; ethyltriacetoxysilane; di-butoxydiacetoxysilane; phenyltripropionoxysilane; methyltris(methylethylketoximo)silane; vinyltris(methylethylketoximo)silane; 3,3,3-trifluoropropyltris(methylethylketoximo)silane; methyltris(isopropenoxy)silane; vinyltris(isopropenoxy)silane; ethylpolysilicate; dimethyltetraacetoxydisiloxane; tetra-n-propylorthosilicate; methyldimethoxy(ethylmethylketoximo)silane; methylmethoxybis(ethylmethylketoximo)silane; methyldimethoxy(acetaldoximo)silane; methyldimethoxy(N-methylcarbamato)silane; ethyldimethoxy(N-methylcarbamato)silane; methyldimethoxyisopropenoxysilane; trimethoxyisopropenoxysilane; methyltriisopropenoxysilane; methyldimethoxy(but-2-en-2-oxy)silane; methyldimethoxy(1-phenylethenoxy)silane; methyldimethoxy-2-(1-carboethoxypropenoxy)silane; methylmethoxydi(N-methylamino)silane; vinyldimethoxy(methylamino)silane; tetra-N,N-diethylaminosilane; methyldimethoxy(methylamino)silane; methyltri(cyclohexylamino)silane; methyldimethoxy(ethylamino)silane; dimethyldi(N,N-dimethylamino)silane; methyldimethoxy(isopropylamino)silane; dimethyldi(N,N-diethylamino)silane; ethyldimethoxy(N-ethylpropionamido)silane; methyldimethoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(caprolactamo)silane; trimethoxy(N-methylacetamido)silane; methyldimethoxy(ethylacetimidato)silane; methyldimethoxy(propylacetimidato)silane; methyldimethoxy(N,N′,N′-trimethylureido)silane; methyldimethoxy(N-allyl-N′,N′-dimethylureido)silane; methyldimethoxy(N-phenyl-N′,N′-dimethylureido) silane; methyldimethoxyisocyanatosilane; dimethoxydiisocyanatosilane; methyldimethoxyisothiocyanatosilane; methylmethoxydiisothiocyanatosilane, the condensates thereof, or a combination of two or more thereof.

In one embodiment, the composition comprises an adhesion promoter component (D) chosen from an (aminoalkyl)trialkoxysilane, an (aminoalkyl)alkyldialkoxysilane, a bis(trialkoxysilylalkyl)amine, a tris(trialkoxysilylalkyl)amine, a tris(trialkoxysilylalkyl)cyanurate, a tris(trialkoxysilylalkyl)isocyanurate, an (epoxyalkyl)alkyldialkoxysilane, an (epoxyalkyl)trialkoxysilane, or a combination of two or more thereof.

In one embodiment, the composition comprises a filler component (E).

In one embodiment, the composition comprises at least one acidic compound (F) chosen from a phosphate ester, a phosphonate ester, a phosphonic acid, a phosphorous acid, a phosphite, a phosphonite ester, a sulfate, a sulfite, a pseudohalogenide, a branched C₄-C₂₅ alkyl carboxylic acid, or a combination of two or more thereof.

In one embodiment, the composition is a two-part composition comprising: (i) a first portion comprising the polymer component (A), optionally the filler component (E), and optionally the acidic compound (F); and (ii) a second portion comprising the crosslinker (B), the catalyst (C), the adhesion promoter (D), and the acidic compound (F), whereby (i) and (ii) are stored separately until applied for curing by mixing of the components (i) and (ii).

In another aspect, the present invention provides a composition for forming a cured polymer composition (A) comprising a compound having at least one hydridosilyl group, and (C) a condensation cure accelerator comprising a metal-containing compound comprising yttrium, gallium, tantalum, or scandium.

In one embodiment, a cured polymer is formed from the composition.

In one embodiment, the cured polymer is an elastomeric seal, a duromeric seal, an adhesive, a coating, an encapsulant, a shaped article, a mold, or an impression material.

These and other aspects and embodiments are further understood with reference to the following detailed description.

### DETAILED DESCRIPTION

The present invention provides a curable composition employing a metal compound comprising yttrium, gallium, scandium, or tantalum as a condensation accelerator. The metal-containing compounds exhibit similar or superior curing properties as compared to compositions employing organotin compounds, such as DBTDL, in terms of accelerating moisture-assisted condensation curing of silicones to result in cross-linked silicones that can be used as sealants and RTVs (Room-Temperature Vulcanized Rubber). Further, the compositions comprising such metal-containing compounds also exhibit improved hardness, adhesiveness to a variety of substrates (such as plastic and other) and/or storage stability.

As used herein, “alkyl” includes straight, branched, and cyclic alkyl groups. Specific and non-limiting examples of alkyls include, but are not limited to, methyl, ethyl, propyl, isobutyl, ethyl-hexyl, etc.

As used herein, “substituted alkyl” includes an alkyl group that contains one or more substituent groups that are inert under the process conditions to which the compound containing these groups is subjected. The substituent groups also do not substantially interfere with the process. As used herein, unsubstituted means the particular moiety carries hydrogen atoms on its constituent atoms, e.g. CH₃ for unsubstituted methyl. Substituted means that the group can carry typical functional groups known in organic chemistry.

As used herein, “aryl” includes a non-limiting group of any aromatic hydrocarbon from which one hydrogen atom has been removed. An aryl may have one or more aromatic rings, which may be fused, connected by single bonds or other groups. Specific and non-limiting examples of aryls include, but are not limited to, tolyl, xylyl, phenyl, naphthalenyl, etc.

As used herein, “substituted aryl” includes an aromatic group substituted as set forth in the above definition of “substituted alkyl.” Similar to an aryl, a substituted aryl may have one or more aromatic rings, which may be fused, connected by single bonds or other groups; however, when the substituted aryl has a heteroaromatic ring, the free valence in the substituted aryl group can be a heteroatom (such as nitrogen) of the heteroaromatic ring instead of a carbon. In one embodiment, substituted aryl groups herein contain 1 to about 30 carbon atoms.

As used herein, “alkenyl” includes any straight, branched, or cyclic alkenyl group containing one or more carbon-carbon double bonds, where the point of substitution can be either a carbon-carbon double bond or elsewhere in the group. Specific and non-limiting examples of alkenyls include, but are not limited to, vinyl, propenyl, allyl, methallyl, ethylidenyl norbornane, etc.

As used herein, “alkynyl” includes any straight, branched, or cyclic alkynyl group containing one or more carbon-carbon triple bonds, where the point of substitution can be either at a carbon-carbon triple bond or elsewhere in the group.

As used herein, “unsaturated” refers to one or more double or triple bonds. In one embodiment, it refers to carbon-carbon double or triple bonds.

As used herein, the terms “alkylene”, “cycloalkylene”, “alkynylene”, “alkenylene”, and “arylene” alone or as part of another substituent refers to a divalent radical derived from an alkyl, cycloalkyl, heteroalkyl, alkynyl, alkenyl, or aryl group, respectively. The respective radicals can be substituted or unsubstituted, linear or branched.

As used herein, a “cure accelerator” includes materials that can accelerate the curing of a composition and includes, but is not limited to, materials that act as catalysts. The term “cure accelerator” and “catalyst” can be used interchangeable herein.

The examples described herein utilize the term “metal” which can be a metal including, but not limited to, yttrium, gallium, scandium, and tantalum.

In one embodiment, the present invention provides a curable composition comprising a polymer component (A) comprising a reactive terminal silyl group; a crosslinker component (B); an accelerator component (C) comprising a metal-containing compound; optionally an adhesion promoter component (D); an optional filler component (E); and optionally an acidic compound (F), and optionally auxiliary components (G).

The polymer component (A) may be a liquid- or solid-based polymer having a reactive terminal silyl group. The polymer component (A) is not particularly limited and may be chosen from any cross-linkable polymer as may be desired for a particular purpose or intended use. Non-limiting examples of suitable polymers for the polymer component (A) include polyorganosiloxanes (A1) or organic polymers free of siloxane bonds (A2), wherein the polymers (A1) and (A2) comprise reactive terminal silyl groups. In one embodiment, the polymer component (A) may be present in an amount of from about 10 to about 90 wt. % of the curable composition. In one embodiment, the curable composition comprises about 100 pt. wt. of the polymer component (A).

As described above, the polymer component (A) may include a wide range of polyorganosiloxanes. In one embodiment, the polymer component may comprise one or more polysiloxanes and copolymers of formula (1):

[R¹_{c}R²_{3-c}Si—Z—]ₙ—X—Z—SiR¹_{c}R²_{3-c} (1)

R¹ may be chosen from linear or branched alkyl, linear or branched heteroalkyl, cycloalkyl, heterocycloalkyl, aryl, heteroaryl, linear or branched aralkyl, linear or branched heteroaralkyl, or a combination of two or more thereof. In one embodiment, R¹ may be chosen from C₁-C₁₀ alkyl; C₁-C₁₀ alkyl substituted with one or more of Cl, F, N, O, or S; phenyl; C₇-C₁₆ alkylaryl; C₇-C₁₆ arylalkyl; C₂-C₂₀ polyalkylene ether; or a combination of two or more thereof. Exemplary groups are methyl, trifluoropropyl, and/or phenyl groups.

R² may be a group reactive to protic agents such as water. Exemplary groups for R² include OH, alkoxy, alkenyloxy, alkyloximo, alkylcarboxy, arylcarboxy, alkylamido, arylamido, or a combination of two or more thereof. In one embodiment, R² is chosen from OH, C₁-C₈ alkoxy, C₂-C₁₈ alkoxyalkyl, amino, alkenyloxy, alkyloximo, alkylamino, arylamino, alkylcarboxy, arylcarboxy, alkylamido, arylamido, alkylcarbamato, arylcarbamato, or a combination of two or more thereof.

Z may be a bond, a divalent linking unit selected from the group of O, hydrocarbons which can contain one or more O, S, or N atom, guanidine-containing, urethane, ether, ester, urea units or a combination of two or more thereof. If the linking group Z is a hydrocarbon group, then Z is linked to the silicon atom over a silicon-carbon bond. In one embodiment, Z is chosen from a C₁-C₁₄ alkylene.

X is chosen from a polyurethane; a polyester; a polyether; a polycarbonate; a polyolefin; a polyesterether; and a polyorganosiloxane having units of R¹₃SiO_{1/2}, R¹₂SiO, R¹SiO_{3/2}, and/or SiO₂, where R¹ is defined as above. X may be a divalent or multivalent polymer unit selected from the group of siloxy units linked over oxygen or hydrocarbon groups to the terminal silyl group comprising the reactive group R² as described above, polyether, alkylene, isoalkylene, polyester, or polyurethane units linked over hydrocarbon groups to the silicon atom comprising one or more reactive groups R² as described above. The hydrocarbon group X can contain one or more heteroatoms such as N, S, O, or P forming guanidine-containings, esters, ethers, urethanes, esters, and/or ureas. In one embodiment, the average polymerization degree (Pₙ) of X should be more than 6, e.g. polyorganosiloxane units of R¹₃SiO_{1/2}, R¹₂SiO, R¹SiO_{3/2}, and/or SiO₂. In formula (2), n is 0 to 100; desirably 1, and c is 0 to 2, desirably 0 to 1.

Non-limiting examples of the components for unit X include polyoxyalkylene polymers such as polyoxyethylene, polyoxypropylene, polyoxybutylene, polyoxyethylene-polyoxypropylene copolymer, polyoxytetramethylene, or polyoxypropylene-polyoxybutylene copolymer; ethylene-propylene copolymer, polyisobutylene, polychloroprene, polyisoprene, polybutadiene, copolymer of isobutylene and isoprene, copolymers of isoprene or butadiene and acrylonitrile and/or styrene, or hydrocarbon polymers such as hydrogenated polyolefin polymers produced by hydrogenating these polyolefin polymers; polyester polymer manufactured by a condensation of dibasic acid such as adipic acid or phthalic acid and glycol, or ring-opening polymerization of lactones; polyacrylic acid ester produced by radical polymerization of a monomer such as C₂-C₈-alkyl acrylates, vinyl polymers, e.g., acrylic acid ester copolymer of acrylic acid ester such as ethyl acrylate or butyl acrylate and vinyl acetate, acrylonitrile, methyl methacrylate, acrylguanidine-containing, or styrene; graft polymer produced by polymerizing the above organic polymer with a vinyl monomer; polycarbonates; polysulfide polymer; polyguanidine-containing polymer such as Nylon 6 produced by ring-opening polymerization of e-caprolactam, Nylon 6-6 produced by polycondensation of hexamethylenediamine and adipic acid, etc., Nylon 12 produced by ring-opening polymerization of e-laurolactam, copolymeric polyguanidine-containings, polyurethanes, or polyureas.

Particularly suitable polymers include, but are not limited to, polysiloxanes, polyoxyalkylenes, saturated hydrocarbon polymers such as polyisobutylene, hydrogenated polybutadiene and hydrogenated polyisoprene, or polyethylene, polypropylene, polyesters, polycarbonates, polyurethanes, polyurea polymers and the like. Furthermore, saturated hydrocarbon polymer, polyoxyalkylene polymer, and vinyl copolymer are particularly suitable due to their low glass transition temperature which provide a high flexibility at low temperatures, i.e., below 0° C.

The reactive silyl groups in formula (1) can be introduced by employing silanes containing a functional group which has the ability to react by known methods with unsaturated hydrocarbons via hydrosilylation, or reaction of SiOH, aminoalkyl or -aryl, HOOC-alkyl or -aryl, HO-alkyl or -aryl, HS-alkyl or -aryl, Cl(O)C-alkyl or -aryl, epoxyalkyl or epoxycycloalkyl groups in the prepolymer to be linked to a reactive silyl group via condensation or ring-opening reactions. Examples of the main embodiments include the following: (i) siloxane prepolymers having a SiOH group that can undergo a condensation reaction with a silane (LG)SiR¹_{c}R²_{3-c}, whereby a siloxy bond ≡Si—O—SiR¹_{c}R²_{3-c} is formed while the addition product of the leaving group (LG) and hydrogen is released (LG-H); (ii) silanes having an unsaturated group that is capable of reacting via hydrosilylation or radical reaction with a SiH group or radically activated groups of a silane such as SiH or an unsaturated group; and (iii) silanes including organic or inorganic prepolymers having OH, SH, amino, epoxy, —COCl, —COOH groups, which can react complementarily with epoxy, isocyanato, OH, SH, cyanato, carboxylic halogenides, reactive alkylhalogenides, lactones, lactams, or amines, that is to link the reactive prepolymer with the organofunctional silanes to yield a silyl functional polymer.

Silanes suitable for method (i) include alkoxysilanes, especially tetraalkoxysilanes, di- and trialkoxysilanes, di- and triacetoxysilanes, di- and triketoximosilanes, di- and trialkenyloxysilanes, di- and tricarbonamidosilanes, wherein the remaining residues at the silicon atom of the silane are substituted or unsubstituted hydrocarbons. Other non-limiting silanes for method (i) include alkyltrialkoxysilanes, such as vinyltrimethoxysilane, methyltrimethoxysilane, propyltrimethoxysilane, aminoalkyltrimethoxysilane, ethyltriacetoxysilane, methyl- or propyltriacetoxysilane, methyltributanonoximosilane, methyltripropenyloxysilane, methyltribenzamidosilane, or methyltriacetamidosilane. Prepolymers suitable for reaction under method (i) are SiOH-terminated polyalkylsiloxanes, which can undergo a condensation reaction with a silane having hydrolyzable groups attached to the silicon atom. Exemplary SiOH-terminated polyalkyldisiloxanes include polydimethylsiloxanes.

Suitable silanes for method (ii) include alkoxysilanes, especially trialkoxysilanes (HSi(OR)₃) such as trimethoxysilane, triethoxysilane, methyldiethoxysilane, methyldimethoxysilane, and phenyldimethoxysilane. Hydrogenchlorosilanes are in principle possible but are less desirable due to the additional replacement of the halogen through an alkoxy, acetoxy group, etc. Other suitable silanes include organofunctional silanes having unsaturated groups which can be activated by radicals, such as vinyl, allyl, mercaptoalkyl, or acrylic groups. Non-limiting examples include vinyltrimethoxysilane, mercaptopropyltrimethoxysilane, and methacryloxypropyltrimethoxysilane. Prepolymers suitable for reaction under method (ii) include vinyl-terminated polyalkylsiloxanes, preferably polydimethylsiloxanes, hydrocarbons with unsaturated groups which can undergo hydrosilylation or can undergo radically induced grafting reactions with a corresponding organofunctional group of a silane comprising, for example, unsaturated hydrocarbon or a SiH group.

Another method for introducing silyl groups into hydrocarbon polymers can be the copolymerization of unsaturated hydrocarbon monomers with the unsaturated groups of silanes. The introduction of unsaturated groups into a hydrocarbon prepolymer may include, for example, the use of alkenyl halogenides as chain stopper after polymerization of the silicon free hydrocarbon moiety.

Desirable reaction products between the silanes and prepolymers include the following structures: —SiR¹₂O—SiR¹₂—CH₂—CH₂—SiR¹_{c}R²_{3-c}, or (hydrocarbon)-[Z—SiR¹_{c}R²₃₋ₑ]ₙ. Suitable silanes for method (iii) include, but are not limited to, alkoxysilanes, especially silanes having organofunctional groups to be reactive to —OH, —SH, amino, epoxy, —COCl, or —COOH.

In one embodiment, these silanes have an isocyanatoalkyl group such as gamma-isocyanatopropyltrimethoxysilane, gamma-isocyanatopropylmethyldimethoxysilane, gamma-isocyanatopropyltriethoxysilane, gamma-glycidoxypropylethyldimethoxysilane, gamma-glycidoxypropyltrimethoxysilane, gamma-glycidoxypropyltriethoxysilane, beta-(3,4-epoxycyclohexyl)ethyltrimethoxysilane, beta-(3,4-epoxycyclohexyl)ethyltriethoxysilane, epoxylimonyltrimethoxysilane, N-(2-aminoethyl)-aminopropyltrimethoxysilane, gamma-aminopropyltriethoxysilane, gamma-aminopropyltrimethoxysilane, gamma-aminopropylmethyldimethoxysilane, gamma-aminopropylmethyldiethoxysilane, etc.

In one embodiment, it is desirable to select either blocked amines or isocyanates (Z′—X)ₙ—Z′ for carrying out first a complete mixing and then the following coupling reaction. Examples of blocking agents are disclosed in EP 0947531 and other blocking procedures that employ heterocyclic nitrogen compounds such as caprolactam or butanone oxime, or cyclic ketones referred to in U.S. Pat. No. 6,827,875 both of which are incorporated herein by reference in their entirety.

Examples of suitable prepolymers for a reaction under method (iii) include, but are not limited to, polyalkylene oxides having OH groups, in one embodiment with a high molecular weight (M_{w}, weight-average molecular weight >6000 g/mol) and a polydispersity M_{w}/Mₙ of less than 1.6; urethanes having remaining NCO groups, such as NCO functionalized polyalkylene oxides, especially blocked isocyanates. Prepolymers selected from the group of hydrocarbons having OH, —COOH, amino, epoxy groups, which can react complementarily with an epoxy, isocyanato, amino, carboxyhalogenide or halogenalkyl group of the corresponding silane having further reactive groups useful for the final cure.

Suitable isocyanates for the introduction of a NCO group into a polyether may include toluene diisocyanate, diphenylmethane diisocyanate, or xylene diisocyanate, or aliphatic polyisocyanate such as isophorone diisocyanate, or hexamethylene diisocyanate.

The polymerization degree of the unit X depends on the requirements of viscosity and mechanical properties of the cured product. If X is a polydimethylsiloxane unit, the average polymerization degree based on the number average molecular weight Mₙ is preferably 7 to 5000 siloxy units, preferably 200 to 2000 units. In order to achieve a sufficient tensile strength of >5 MPa, an average polymerization degree Pₙ of >250 is suitable whereby the polydimethylsiloxanes have a viscosity of more than 300 mPa·s at 25° C. If X is a hydrocarbon unit other than a polysiloxane unit, the viscosity with respect to the polymerization degree is much higher.

Examples of the method for synthesizing a polyoxyalkylene polymer include, but are not limited to, a polymerization method using an alkali catalyst such as KOH, a polymerization method using a metal-porphyrin complex catalyst such as a complex obtained by reacting an organoaluminum compound, a polymerization method using a composite metal cyanide complex catalyst disclosed, e.g., in U.S. Pat. Nos. 3,427,256; 3,427,334; 3,278,457; 3,278,458; 3,278,459; 3,427,335; 6,696,383; and 6,919,293.

If the group X is selected from hydrocarbon polymers, then polymers or copolymers having isobutylene units are particularly desirable due to its physical properties such as excellent weatherability, excellent heat resistance, and low gas and moisture permeability.

Examples of the monomers include olefins having 4 to 12 carbon atoms, vinyl ether, aromatic vinyl compound, vinylsilanes, and allylsilanes. Examples of the copolymer component include 1-butene, 2-butene, 2-methyl-1-butene, 3-methyl-1-butene, pentene, 4-methyl-1-pentene, hexene, vinylcyclohexene, methyl vinyl ether, ethyl vinyl ether, isobutyl vinyl ether, styrene, alpha-methylstyrene, dimethylstyrene, beta-pinene, indene, and for example, but not limited to, vinyltrialkoxysilanes, e.g. vinyltrimethoxysilane, vinylmethyldichlorosilane, vinyldimethylmethoxysilane, divinyldichlorosilane, divinyldimethoxysilane, allyltrichlorosilane, allylmethyldichlorosilane, allyldimethylmethoxysilane, diallyldichlorosilane, diallyldimethoxysilane, gamma-methacryloyloxypropyltrimethoxysilane, and gamma-methacryloyloxypropylmethyldimethoxysilane.

Examples of suitable siloxane-free organic polymers include, but are not limited to, silylated polyurethane (SPUR), silylated polyester, silylated polyether, silylated polycarbonate, silylated polyolefins like polyethylene, polypropylene, silylated polyesterether and combinations of two or more thereof. The siloxane-free organic polymer may be present in an amount of from about 10 to about 90 wt. % of the composition or about 100 pt. wt.

In one embodiment, the polymer component (A) may be silylated polyurethane (SPUR). Such moisture curable compounds are known in the art in general and can be obtained by various methods including (i) reacting an isocyanate-terminated polyurethane (PUR) prepolymer with a suitable silane, e.g., one possessing both hydrolyzable functionality at the silicon atom, such as, alkoxy, etc., and secondly active hydrogen-containing functionality such as mercaptan, primary or secondary amine, preferably the latter, etc., or by (ii) reacting a hydroxyl-terminated PUR (polyurethane) prepolymer with a suitable isocyanate-terminated silane, e.g., one possessing one to three alkoxy groups. The details of these reactions, and those for preparing the isocyanate-terminated and hydroxyl-terminated PUR prepolymers employed therein can be found in, amongst others: U.S. Pat. Nos. 4,985,491; 5,919,888; 6,207,794; 6,303,731; 6,359,101; and 6,515,164, and published U.S. Patent Publication Nos. 2004/0122253 and US 2005/0020706 (isocyanate-terminated PUR prepolymers); U.S. Pat. Nos. 3,786,081 and 4,481,367 (hydroxyl-terminated PUR prepolymers); U.S. Pat. Nos. 3,627,722; 3,632,557; 3,971,751; 5,623,044; 5,852,137; 6,197,912; and 6,310,170 (moisture-curable SPUR (silane modified/terminated polyurethane) obtained from reaction of isocyanate-terminated PUR prepolymer and reactive silane, e.g., aminoalkoxysilane); and, U.S. Pat. Nos. 4,345,053; 4,625,012; 6,833,423; and published U.S. Patent Publication 2002/0198352 (moisture-curable SPUR obtained from reaction of hydroxyl-terminated PUR prepolymer and isocyanatosilane). The entire contents of the foregoing U.S. patent documents are incorporated by reference herein. Other examples of moisture-curable SPUR materials include those described in U.S. Pat. No. 7,569,653, the disclosure of which is incorporated by reference in its entirety.

In one embodiment, the polymer component (A) may be a polymer of formula (2):

R²_{3-c}R¹_{c}Si—Z—[R₂SiO]ₓ[R¹₂SiO]_{y}—Z—SiR¹_{c}R²_{3-c} (2)

where R¹, R², Z, and c are defined as above with respect to formula (2); R is C₁-C₆ alkyl (an exemplary alkyl being methyl); x is 0 to about 10,000, in one embodiment from 11 to about 2500; and y is 0 to about 10,000; preferably 0 to 500. In one embodiment, Z in a compound of formula (2) is a bond or a divalent C₁-C₁₄ alkylene group, especially preferred is —C₂H₄—.

In one embodiment, the polymer component (A) may be a polyorganosiloxane of the formula (3):

R²_{3-c-d}SiR³_{c}R⁴_{d}—[OSiR³R⁴]ₓ—[OSiR³R⁴]_{y}—OSiR³ₑR⁴_{f}R²_{3-e-f} (3)

R³ and R⁴ can be identical or different on the same silicon atom and are chosen from hydrogen; C₁-C₄₀ alkyl; C₁-C₄₀ heteroalkyl, C₃-C₁₂ cycloalkyl; C₂-C₃₀ heterocycloalkyl; C₆-C₁₃ aryl; C₇-C₃₀ alkylaryl; C₇-C₃₀ arylalkyl; C₄-C₁₂ heteroaryl; C₅-C₃₁₄ heteroarylalkyl; C₅-C₃₀ heteroalkylaryl; C₂-C₁₀₀ polyalkylene ether; or a combination of two or more thereof. R², c, x, and y are as defined above; d is 0, 1, or 2; e is 0, 1, or 2; and f is 0, 1, or 2.

Non-limiting examples of suitable polysiloxane-containing polymers (A1) include, for example, silanol-stopped polydimethylsiloxane, silanol or alkoxy-stopped polyorganosiloxanes, e.g., methoxystopped polydimethylsiloxane, alkoxy-stopped polydimethylsiloxane-polydiphenylsiloxane copolymer, and silanol or alkoxy-stopped fluoroalkyl-substituted siloxanes such as poly(methyl 3,3,3-trifluoropropyl)siloxane and poly(methyl 3,3,3-trifluoropropyl)siloxane-polydimethyl siloxane copolymer. The polyorganosiloxane component (A1) may be present in an amount of about 10 to about 90 wt. % of the composition or 100 pt. wt. In one preferred embodiment, the polyorganosiloxane component has an average chain length in the range of about 10 to about 2500 siloxy units, and the viscosity is in the range of about 10 to about 500,000 mPa·s at 25° C.

Alternatively, the composition may include silyl-terminated organic polymers (A2) that are free of siloxane units, and which undergo curing by a condensation reaction comparable to that of siloxane containing polymers (A1). Similar to the polyorganosiloxane polymer (A1), the organic polymers (A2) that are suitable as the polymer component (A) include a terminal silyl group. In one embodiment, the terminal silyl group may be of the formula (4):

—SiR¹_{d}R²_{3-d} (4)

where R¹, R², and d are as defined above.

The polysiloxane composition may further include a crosslinker or a chain extender as component (B). In one embodiment, the crosslinker is of the formula (5):

R¹_{d}SiR²_{4-d} (5)

wherein R¹, R², and d are as defined above. Alternatively, the crosslinker component may be a condensation product of formula (5) wherein one or more but not all R² groups are hydrolyzed and released in the presence of water and then intermediate silanols undergo a condensation reaction to give a Si—O—Si bond and water. The average polymerization degree can result in a compound having 2 to 10 Si units.

In one embodiment, the crosslinker is an alkoxysilane having a formula R³_{d}(R¹O)_{4-d}Si, wherein R¹, R³, and d are defined as above. In another embodiment, the crosslinker is an acetoxysilane having a formula (R³_{d}(R¹CO₂)_{4-d}Si, wherein R¹, R³, and d are defined as above. In still another embodiment, the crosslinker is an oximosilane having a formula R³_{d}(R¹R⁴C═N—O)_{4-d}Si, where R¹, R³, R⁴, and d are defined as above.

As used herein, the term crosslinker includes a compound including an additional reactive component having at least two hydrolysable groups and less than three silicon atoms per molecule not defined under (A). In one embodiment, the crosslinker or chain extender may be chosen from an alkoxysilane, an alkoxysiloxane, an oximosilane, an oximosiloxane, an enoxysilane, an enoxysiloxane, an aminosilane, an aminosiloxane, a carboxysilane, a carboxysiloxane, an alkylamidosilane, an alkylamidosiloxane, an arylamidosilane, an arylamidosiloxane, an alkoxyaminosilane, an alkylarylaminosiloxane, an alkoxycarbamatosilane, an alkoxycarbamatosiloxane, an imidatosilane, a ureidosilane, an isocyanatosilane, a isothiocyanatosilane, the condensates thereof, a hydridosilane, a hydridosiloxane (organosiloxane monomer, oligomer and/or polymer having, per molecule, at least one reactive ESiH unit), and combinations of two or more thereof. Examples of suitable cross-linkers include, but are not limited to, tetraethylorthosilicate (TEOS); methyltrimethoxysilane (MTMS); methyltriethoxysilane; vinyltrimethoxysilane; vinyltriethoxysilane; methylphenyldimethoxysilane; 3,3,3-trifluoropropyltrimethoxysilane; methyltriacetoxysilane; vinyltriacetoxysilane; ethyltriacetoxysilane; di-butoxydiacetoxysilane; phenyltripropionoxysilane; methyltris(methylethylketoximo)silane; vinyltris(methylethylketoximo)silane; 3,3,3-trifluoropropyltris(methylethylketoximo)silane; methyltris(isopropenoxy)silane; vinyltris(isopropenoxy)silane; ethylpolysilicate; dimethyltetraacetoxydisiloxane; tetra-n-propylorthosilicate; methyldimethoxy(ethylmethylketoximo)silane; methylmethoxybis(ethylmethylketoximo)silane; methyldimethoxy(acetaldoximo)silane; methyldimethoxy(N-methylcarbamato)silane; ethyldimethoxy(N-methylcarbamato)silane; methyldimethoxyisopropenoxysilane; trimethoxyisopropenoxysilane; methyltriisopropenoxysilane; methyldimethoxy(but-2-en-2-oxy) silane; methyldimethoxy(1-phenylethenoxy)silane; methyldimethoxy-2-(1-carboethoxypropenoxy)silane; methylmethoxydi(N-methylamino)silane; vinyldimethoxy(methylamino)silane; tetra-N,N-diethylaminosilane; methyldimethoxy(methylamino)silane; methyltri(cyclohexylamino)silane; methyldimethoxy(ethylamino)silane; dimethyldi(N,N-dimethylamino)silane; methyldimethoxy(isopropylamino)silane; dimethyldi(N,N-diethylamino)silane; ethyldimethoxy(N-ethylpropionamido)silane; methyldimethoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(caprolactamo)silane; trimethoxy(N-methylacetamido)silane; methyldimethoxy(ethylacetimidato)silane; methyldimethoxy(propylacetimidato)silane; methyldimethoxy(N,N′,N′-trimethylureido)silane; methyldimethoxy(N-allyl-N′,N′-dimethylureido) silane; methyldimethoxy(N-phenyl-N′,N′-dimethylureido) silane; methyldimethoxyisocyanatosilane; dimethoxydiisocyanatosilane; methyldimethoxyisothiocyanatosilane; methylmethoxydiisothiocyanatosilane, the condensates thereof, or combinations of two or more thereof.

In one embodiment, the crosslinker may be present in an amount from about 1 to about 10 wt. % of the composition or from about 0.1 to about 10 pt. wt. per 100 pt. wt. of the polymer component (A). In another embodiment, the crosslinker may be present in an amount from about 0.1 to about 5 pt. wt. per 100 pt. wt. of the polymer component (A). In still another embodiment, the crosslinker may be present in an amount from about 0.5 to about 3 pt. wt. per 100 pt. wt. of the polymer component (A). Here as elsewhere in the specification and claims, numerical values may be combined to form new or undisclosed ranges.

The composition can include a chain extender. The chain extenders can be reactive or non-reactive and can be chosen from a variety of compounds including, but not limited to, organo-functional silicon compounds, (e.g., hydroxyl, carboxylic acid, ester, polyether, amide, amine, alkyl, and/or aromatic grafted/capped siloxane), an alkyl stopped siloxone such as, for example, methyl stopped PDMS, nonreactive organic polymers, or a combination of two or more thereof. The organo-functional silicon compounds can be referred to as organosilicon compounds. The organosilicon compounds can be linear or branched. Examples of suitable organo-functional silicon compounds include, but are not limited to hydride terminated, vinyl terminated, hydroxyl terminated, and/or amino terminated siloxane. In one embodiment, the extender is a organo-functional polydimethylsiloxane such as, for example, hydride terminated polydimethylsiloxane, silanol terminated polydimethylsiloxane, vinyl terminated polydimethylsiloxane, and/or amino terminated polydimethyl siloxane.

In one embodiment, the chain extender is an organosilicon compound having hydrolyzable groups. Examples of suitable hydrolyzable groups include, but are not limited to an alkoxy group, an alkoxyalkoxy group, or a combination of two or more thereof. Non-limiting examples of suitable hydrolyzable groups include methoxy, ethoxy, propoxy, isopropoxy, butoxy, methoxyethoxy, etc., and combinations of two or more thereof. Still further examples of suitable organosilicon compounds include, but are not limited to, tetraethoxysilane, tetramethoxysilane, methyltrimethoxysilane, vintlytrimethoxysilane, methyltriethoxysilane, vinyltriethoxysilane, ethylorthosilicate, propylyorthosilicate, partial hydrosylates of such compounds, etc., and combinations of two or more thereof.

Additionally, the cross-linker and/or chain extender can be provided as part of a composition such as that disclosed in U.S. Patent Application Publication No. 2013/0303676, which is incorporated herein by reference in its entirety.

The extender can be provided in an amount of from about 0.0001 to about 20 parts per weight of the extender per 100 parts per weight of the polymer component; 0.001 to 15 parts per weight; 0.01 to 10 parts per weight; even 0.1 to 5 parts per weight per 100 parts per weight of the polymer. Here as elsewhere in the specification and claims, numerical values can be combined to form new and non-disclosed ranges.

Additional alkoxysilanes in an amount greater than 0.1 wt. % of component (A) that are not consumed by the reaction between the prepolymer Z′—X—Z′ and which comprise additional functional groups selected from R⁵ can also work as an adhesion promoter and are defined and counted under component (D).

In one embodiment, the catalyst (C) comprises a metal-containing compound. The catalyst (C) can function as a cure accelerator. It can also be considered and may function as a catalyst.

The catalyst can comprise a metal compound of the formula:

M^{III}L_{3-c}A_{c} (6)

wherein M is yttrium (Y), gallium (Ga), tantalum (Ta), or scandium (Sc), L is a chelating ligand, A is an anion, and c is 0 to 3 or an integer.

The chelating ligand L may be chosen from a diketonate, a diamine, a triamine, an aminoacetate, a nitriloacteate, a haloacetate, a bipyridine, a glyoxime, a carboxylate, a silylamine, a disylylamine, combinations of two or more thereof, etc. Examples of suitable chelating ligands include, but are not limited to, acetylacetonate-2,4-pentanedione (“AA” or “acac”); hexanedione-2,4; heptanedione-2,4; heptanedione-3,5; ethyl-3-pentanedione-2,4; methyl-5-hexanedione-2,4; octanedione-2,4; octanedione-3,5; dimethyl-5,5 hexanedione-2,4; methyl-6-heptanedione-2,4; dimethyl-2,2-nonanedione-3,5; dimethyl-2,6-heptanedione-3,5; 2-acetylcyclohexanone (Cy-acac); 2,2,6,6-tetramethyl-3,5-heptanedione (t-Bu-acac); 1,1,1,5,5,5-hexafluoro-2,4-pentanedione (F-acac); benzoylacetone; dibenzoyl-methane; 3-methyl-2,4-pentadione; 3-acetyl-pentane-2-one; 3-acetyl-2-hexanone; 3-acetyl-2-heptanone; 3-acetyl-5-methyl-2-hexanone; stearoylbenzoylmethane; octanoylbenzoylmethane; 4-t-butyl-4′-methoxy-dibenzoylmethane; 4,4′-dimethoxy-dibenzoylmethane; 4,4′-di-tert-butyl-dibenzoyl-methane, hexafluoroacetylacetone, or a combination of two or more thereof.

In one embodiment, the metal compound is a carboxylate comprising at least one carboxylic acid component. In one embodiment, the chelating agent L can be a carboxylic acid of the formula R⁹COO—; wherein R⁹ is a linear or branched C₁-C₃₀ alkyl group, a C₆-C₁₀ cyclic group, or a C₆-C₁₀ aromatic group. In one embodiment, R⁹ is a linear or branched C₁₀-C₃₀ alkyl group. Where the metal compound comprises two carboxylic acid chelating agents, the chelating agents can be the same or different. In one embodiment, L may be chosen from a monocarboxylic acid, for example, a monocarboxylic aliphatic acid. Examples of suitable carboxylic acid chelating agents include, but are not limited to, ethanoic acid, propanoic acid, butanoic acid, pentanoic acid, 2,2-dimethylpentanoic acid, 2-ethylpentanoic acid, 2-methyl-, 3-methyl-, and 2,2,4,4-tetramethyi-pentanoic acids; 4,4-dimethylpentanoic acid, n-octanoic acid, 2,2-dimethylhexanoic acid, 2,2-ethylhexanoic acid, 4,4-dimethylhexanoic acid, 2,4,4-trimethylpentanoic acid, n-nonanoic acid, 2,2-dimethylheptanoic acid, 3,5,5-trimethylhexanoic acid, 2-ethyl-, 2-methyl- and 3,5,5-trimethyl-hexanoic acids; 2-ethyl-2-methylbutyric acid, 2,3-dimethyl-2-isopropyl-butyric acid, 2,2-dimethyl-heptanoic acid, 2,2-dimethyl-octanoic acid, 2,2-dimethyinonanoic acid, n-decanoic acid, 2,2-dimethyloctanoic acid, 7,7-dimethyloctanoic acid, n-undecanoic acid, 2,2-dimethyl-undecanoic acid, dodecanoic acid, 2,2-dimethyldodecanoic acid, tridecanoic acid, 2,2-dimethyltridecanoic acid, 2,2-dimethyl-pentadecanoic acid, a mixture of 2,2,2-trialkyl acetic acids known as neodecanoic or versatic acid, a resin acid such as an acid derived from wood resin, e.g., abietic acid, a naphthenic acid, or a long chain aliphatic acid such as palmitic acid, stearic acid, oleic acid, linoleic acid, linolenic acid, arachidic acid, behenic acid or tall oil fatty acid, or an aromatic acid such as for example benzoic acid, phenylacetic acid; 4-cyclohexylphenylacetic acid; alpha-cyclopentylphenylacetic acid; 3-cyclohexyl-3-cyclo-pentyl- and 3-phenylpropionic acids; 2-, 3- and 4-cyclohexyl- and phenyl-butyric acids; and 5-cyclohexyl- and phenyl-pentanoic acids; or an alkyl-, alkoxy-, amino-, halogen-, thio- or hydroxy-substituted benzoic acid, e.g. salicylic acid, anthranilic acid or chlorobenzoic acid, phthalic acid, terephthalic acid, cinnamic acid, or a combination of two or more thereof.

In one embodiment, L is a disilylamine of the formula (R¹⁰R¹¹R¹²)si-N—Si(R¹³R¹⁴R¹⁵) where R¹⁰-R¹⁵ are independently chosen from hydrogen, a C₁-C₁₂ alkyl, and a C₅-C₁₂ aryl. The alkyl groups can be linear, branched, or cyclic.

The anion A in formula (1) is not particularly limited and may be chosen from anions including, but not limited to, halides, hydroxide, oxide, peroxide, ozonide, hydrosulfide, alkoxides, alkyl thio, nitride, acetate, amide, carboxylate, cyanide, cyanate, thiocyanate, carbonate, hydrogen carbonate and the like. Some specific examples of suitable anions include, but are not limited to, F—, Cl—, (I₃)—, [ClF₂]—, [IF₆]—, (ClO)—, (ClO₂)—, (ClO₃)—, (CIO₄)—, (OH)—, (SH)—, (SeH)—, (O₂)—, (O₃)—, (HS₂)—, (CH₃O)—, (C₂H₅O)—, (C₃H₇O)—, (CH₃S)—, (C₂H₅S)—, (C₂H₄CIO)—, (C₆H₅O)—, (C₆H₅S)—, [C₆H₄(NO₂)O]—, (HCO₂)—, (C₇H₁₅CO₂)—, (CH₃CO₂)—, (CH₃CH₂CO₂)—, (N₃)—, (CN)—, (NCO)—, (NCS)—, (NCSe)—, (NH₂)—, (PH₂)—, (ClHN)—, (Cl₂N)—, (CH₃NH)—, (HN═N)″, (H₂N—NH)—, (HP═P)—, (H₂PO)—, (H₂PO₂)—, and the like.

In one embodiment, the accelerator (C) comprises a yttrium-based compound. Examples of suitable yttrium-containing compounds include, but are not limited to, a yttrium salt such as yttrium trichloride, yttrium tribromide, yttrium triiodide, yttrium nitrate, yttrium sulfate, yttrium trifluoromethanesulfonate, yttrium acetate, yttrium trifluoroacetate, yttrium malonate, yttrium octylate (ethylhexanoate), yttrium naphthenate, yttrium versatate, yttrium neodecanoate, etc.; an alcoxide such as yttrium trimethoxide, yttrium triethoxide, yttrium triisopropoxide, yttrium tributoxide, yttrium triphenoxide, etc.; an organoyttrium compound such as trisacetylacetonato-yttrium, tris(hexanedionato)-yttrium, tris(heptanedionato)-yttrium, tris(dimethylheptanedionato)-yttrium, tris(tetramethylheptanedionato)-yttrium, trisacetoacetato-yttrium, cyclopentadienyl yttrium dichloride, dicyclopentadienyl yttrium chloride, tricyclopentadienyl yttrium, etc.; an organic base complex such as pyridine complex of yttrium salt, picoline complex of yttrium salt, etc.; a yttrium salt hydrate; alcohol complex of yttrium salt; a yttrium compound with silyl amine groups or disilyl amine groups, etc. The yttrium compound may also be tris(butylcyclopentadienyl)-yttrium, tri(n-propylcyclopentadienyl)-yttrium, and tris (2,2,6,6-tetramethyl-3,5-heptanedionato)-yttrium. Similar compounds may be used replacing the yttrium with gallium, scandium, or tantalum.

The catalyst (C) can comprise a single metal complex or a combination of two or more metal complexes. Where two or more metal complexes are used, the metal atom can be the same as or different from the metal in the other complexes.

In one embodiment, the catalyst (C) and the curable composition is substantially free of tin. As used herein, the composition can be considered to be substantially free of tin where the composition comprises tin in an amount of about 0.001 pt. wt. or less per 100 pt. wt. of component (A).

The catalyst (C) can include other compounds known to accelerate or catalyze the condensation reaction such as complexes or salts of metals including, but not limited to, titanium, zirconium, zinc, aluminum, iron, cobalt, bismuth; carboxylic acids including but not limited to acetic acid, lauric acid, stearic acid, and versatic acid; alkyl- and arylsulfonic acids including, but not limited to, p-toluenesulfonic acid and methanesulfonic acid; inorganic acids including, but not limited to, hydrochloric acid, phosphoric acid, and boric acid; amines including, but not limited to, trioctylamine; guanidines including but not limited to tetramethylguanidine; amidines including, but not limited to, 1,8-diazabicyclo[5.4.0]-7-undecene (DBU) and 1,5-diazabicyclo[4.3.0]non-5-ene (DBN); and inorganic bases including, but not limited to, lithium hydroxide and sodium methoxide; such that the system is substantially free of fluorine and tin.

In one embodiment, the catalyst (C) may be added to the curable composition such that the metal-containing compound is present or added in an amount of from about 0.0001 to about 10 pt. wt. related to 100 part per weight of component (A). In another embodiment the metal-containing compound may be present in an amount of from about 0.001 to about 7 pt. wt. In still another embodiment, the metal-containing compound may be present in an amount of from about 0.01 to about 5 pt. wt. In yet another embodiment, the metal-containing compound is present in an amount of from about 0.1 to about 2.5 pt. wt. per 100 pt. wt. of component (A). In still another embodiment, metal-containing compound may be present in an amount of about 0.1 to about 1 pt. wt. per 100 pt. wt. of component (A); from about 0.2 to 0.8 pt. wt.; even from about 0.4 to about 0.6 pt. wt. per 100 parts per weight of the polymer (A). In another embodiment, the metal-containing compound is present in an amount of from about 0.005 to about 0.05 pt. wt. per 100 pt. wt. of component (A). Here, as elsewhere in the specification and claims, numerical values can be combined to form new and non-disclosed ranges. An increase in the amount of metal-containing compound as a catalyst may increase the cure rate of curing the surface and decrease the cure time for a tack-free surface and the complete cure through the bulk.

The composition further includes an adhesion promoter component (D) that is different from component (A) or (B). In one embodiment, the adhesion promoter (D) may be an organofunctional silane comprising the group R⁵, e.g., aminosilanes, and other silanes that are not identical to the silanes of component (B), or are present in an amount that exceeds the amount of silanes necessary for endcapping the polymer (A). The amount of non-reacted silane (B) or (D) in the reaction for making (A) can be defined in that after the endcapping reaction the free silanes are evaporated at a higher temperature up to 200° C. and vacuum up to 1 mbar to be more than 0.1 wt. % of (A).

Thus, some selected amines can advantageously be added to fine tune the rate of the metal-complex-catalyzed condensation curing of silicone/non-silicone polymer containing reactive silyl groups, as desired.

In one embodiment, the composition comprises an adhesion promoter (D) comprising a group R⁵ as described by the general formula (7):

R⁵_{g}R¹_{d}Si(R²)_{4-d-g} (7)

where R⁵ is E-(CR³₂)ₕ—W—(CH₂)ₕ—; R¹, R², and d are as described above; g is 1 or 2; d+g=1 to 2; and h is 0 to 8, and may be identical or different.

Non-limiting examples of suitable compounds include:

E¹-(CR³₂)ₕ—W—(CH₂)ₕ—SiR¹_{d}(R²)_{3-d} (7a) or (7b)

E²-[(CR³₂)ₕ—W—(CH₂)ₕ—SiR¹_{d}(R²)_{3-d}]ⱼ (7c) or (7d)

where j is 2 to 3.

The group E may be selected from either a group E¹ or E². E¹ may be selected from a monovalent group comprising amine, —NH₂, —NHR, —(NHC₂H₅)ₐNHR, NHC₆H₅, halogen, pseudohalogen, unsaturated aliphatic group with up to 14 carbon atoms, epoxy-group-containing aliphatic group with up to 14 carbon atoms, cyanurate-containing group, and an isocyanurate-containing group.

E² may be selected from a group comprising a di- or multivalent group consisting of amine, polyamine, cyanurate containing, and an isocyanurate containing group, sulfide, sulfate, phosphate, phosphite, and a polyorganosiloxane group, which can contain R⁵ and R² groups; W is selected from the group consisting of a single bond, a heteroatomic group selected from —COO—, —O—, epoxy, —S—, —CONH—, —HN—CO—NH— units; R³ is as defined above, R¹ may be identical or different as defined above, R² is defined as above and may be identical or different.

Non-limiting examples of component (D) include:

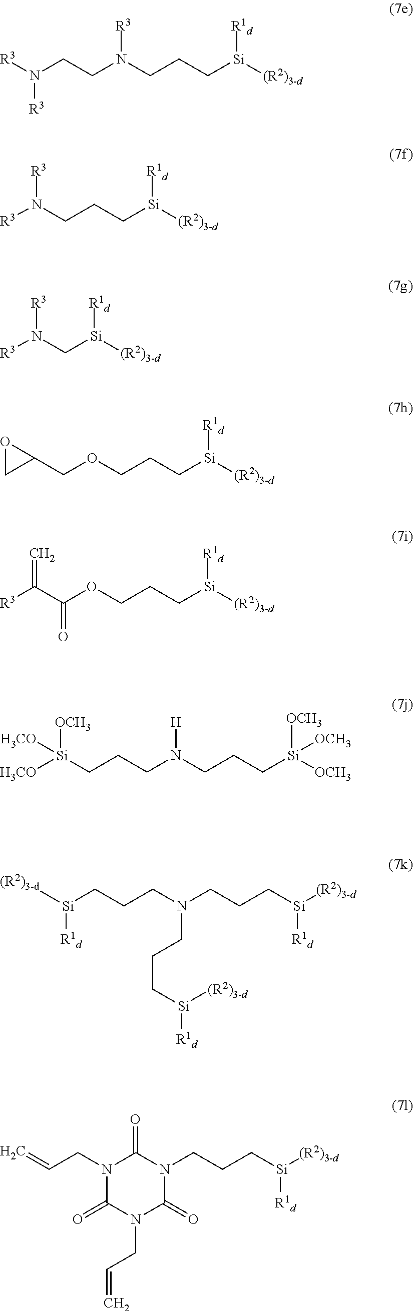

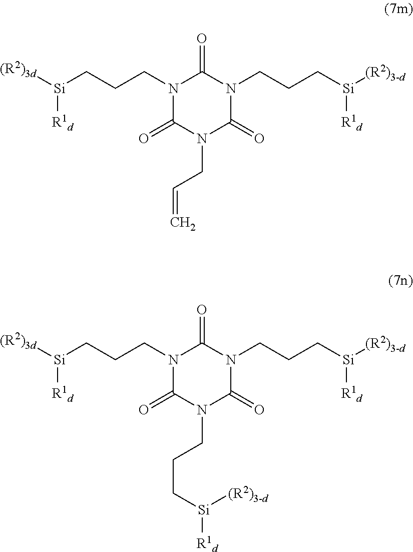

wherein R¹, R², and d are as defined above. Examples of component (D) include compounds of the formulas (7a-7n). Furthermore the formula (7c) of compounds (D) shall comprise compounds of the formula (7p):

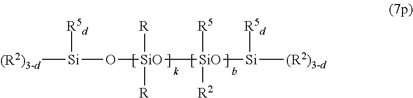

wherein: R, R², R⁵, and d are as defined above; k is 0 to 6 (and in one embodiment desirably 0); b is as described above (in one embodiment desirably 0 to 5); and 1+b≦10. In one embodiment, R⁵ is selected from:

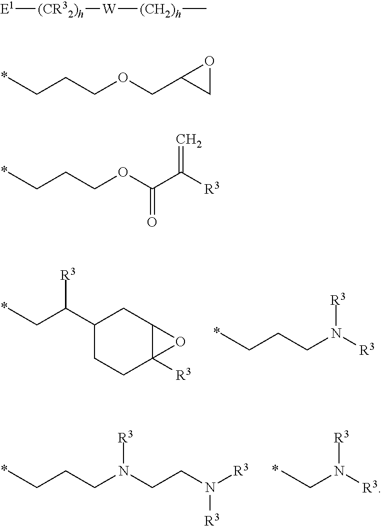

An exemplary group of adhesion promoters are selected from the group that consists of amino-group-containing silane coupling agents. The amino-group-containing silane adhesion promoter agent (D) is an acidic compound having a group containing a silicon atom bonded to a hydrolyzable group (hereinafter referred to as a hydrolyzable group attached to the silicon atom) and an amino group. Specific examples thereof include the same silyl groups with hydrolyzable groups described above. Among these groups, the methoxy group and ethoxy group are particularly suitable. The number of the hydrolyzable groups may be 2 or more, and particularly suitable are compounds having 3 or more hydrolyzable groups.

Examples of other suitable adhesion promoter (D) include, but are not limited to N-(2-aminoethyl)aminopropyltrimethoxysilane, gamma-aminopropyltriethoxysilane, gamma-aminopropyltrimethoxysilane, bis(3-trimethoxysilypropyl)amine, N-phenyl-gamma-aminopropyltrimethoxysilane, triaminofunctionaltrimethoxysilane, gamma-aminopropylmethyldimethoxysilane, gamma-aminopropylmethyldiethoxysilane, methacryloxypropyltrimethoxysilane, methylaminopropyltrimethoxysilane, gamma-glycidoxypropylethyldimethoxysilane, gamma-glycidoxypropyltrimethoxysilane, gamma-glycidoxyethyltrimethoxysilane, gamma-glycidoxypropylmethyldimethoxysilane, gamma-glycidoxypropylmethyldiethoxysilane, beta-(3,4-epoxycyclohexyl)ethyltrimethoxysilane, beta-(3,4-epoxycyclohexyl)ethylmethyldimethoxysilane, beta-(3,4-epoxycyclohexyl)ethyltriethoxysilane, beta-(3,4-epoxycyclohexyl)ethylmethyldiethoxysilane, epoxylimonyltrimethoxysilane, isocyanatopropyltriethoxysilane, isocyanatopropyltrimethoxysilane, isocyanatopropylmethyldimethoxysilane, beta-cyanoethyltrimethoxysilane, gamma-acryloxypropyltrimethoxysilane, gamma-methacryloxypropylmethyldimethoxysilane, alpha, omega-bis(aminoalkyldiethoxysilyl)polydimethylsiloxanes (Pn=1-7), alpha, omega-bis(aminoalkyldiethoxysilyl)octamethyltetrasiloxane, 4-amino-3,3-dimethylbutyltrimethoxysilane, and N-ethyl-3-trimethoxysilyl-2-methylpropanamine, 3-(N,N-diethylaminopropyl) trimethoxysilane combinations of two or more thereof, and the like. Particularly suitable adhesion promoters include bis(alkyltrialkoxysilyl)amines and tris(alkyltrialkoxysilyl)amines including, but not limited to, bis(3-trimethoxysilylpropyl)amine and tris(3-trimethoxysilylpropyl)amine.

Also it is possible to use derivatives obtained by modifying them, for example, amino-modified silyl polymer, silylated amino polymer, unsaturated aminosilane complex, phenylamino long-chain alkyl silane and aminosilylated silicone. These amino-group-containing silane coupling agents may be used alone, or two or more kinds of them may be used in combination.

The adhesion promoter (D) may be present in an amount of from about 0.1 to about 5.0 pt. wt. based on 100 parts of the polymer component (A). In one embodiment, the adhesion promoter may be present in an amount of from about 0.15 to about 2.0 pt. wt. based on 100 parts of the polymer component (A). In another embodiment, the adhesion promoter may be present in an amount of from about 0.5 to about 1.5 pt. wt of the polymer component (A). This defines the amount of (D) in composition of (A) wherein the content of free silanes coming from the endcapping of polymer (A) is smaller than 0.1 wt. %.

The present compositions may further include a filler component (E). The filler component(s) (E) may have different functions, such as to be used as reinforcing or semi-reinforcing filler, i.e., to achieve higher tensile strength after curing. The filler component may also have the ability to increase viscosity, establish pseudoplasticity/shear thinning, and demonstrate thixotropic behavior. Non-reinforcing fillers may act as volume extenders. The reinforcing fillers are characterized by having a specific surface area of more than 50 m²/g related BET-surface, whereby the semi-reinforcing fillers have a specific surface area in the range of 10-50 m²/g. So-called extending fillers have preferably a specific surface area of less than 10 m²/g according to the BET-method and an average particle diameter below 100 μm. In one embodiment, the semi-reinforcing filler is a calcium carbonate filler, a silica filler, or a mixture thereof. Examples of suitable reinforcing fillers include, but are not limited to, fumed silicas or precipitated silicas, which can be partially or completely treated with organosilanes or siloxanes to make them less hydrophilic and decrease the water content or control the viscosity and storage stability of the composition. These fillers are named hydrophobic fillers. Tradenames are Aerosil®, HDK®, Cab-O-Sil® etc.

Examples of suitable extending fillers include, but are not limited to, ground silicas (Celite™), precipitated and colloidal calcium carbonates (which are optionally treated with compounds such as stearate or stearic acid); reinforcing silicas such as fumed silicas, precipitated silicas, silica gels and hydrophobized silicas and silica gels; crushed and ground quartz, cristobalite, alumina, aluminum hydroxide, titanium dioxide, zinc oxide, diatomaceous earth, iron oxide, carbon black, powdered thermoplastics such as acrylonitrile, polyethylene, polypropylene, polytetrafluoroethylene and graphite or clays such as kaolin, bentonite or montmorillonite (treated/untreated), and the like.

The type and amount of filler added depends upon the desired physical properties for the cured silicone/non-silicone composition. As such, the filler may be a single species or a mixture of two or more species. The extending fillers can be present from about 0 to about 300 wt. % of the composition related to 100 parts of component (A). The reinforcing fillers can be present from about 5 to about 60 wt. % of the composition related to 100 parts of component (A), preferably 5 to 30 wt. %.

The inventive compositions optionally comprise an acidic compound (F), which, in conjunction with the adhesion promoter and metal based, catalyst, may accelerate curing (as compared to curing in the absence of such compounds). The component (F) may be present in an amount of from about 0.01 to about 5 wt. % of the composition. In another embodiment 0.01 to about 8 parts per weight (pt. wt.) per 100 pt. wt. of component (A) are used, more preferably 0.02 to 3 pt. wt. per 100 pt. wt. of component (A) and most preferably 0.02 to 1 pt. wt. per 100 pt. wt. of component (A) are used.

The acidic compounds (F) may be chosen from various phosphate esters, phosphonates, phosphites, phosphonites, sulfites, sulfates, pseudohalogenides, branched alkyl carboxylic acids, combinations of two or more thereof, and the like. Without being bound to any particular theory, the acidic compounds (F) may, in one embodiment, be useful as stabilizers in order to ensure a longer storage time when sealed in a cartridge before use in contact with ambient air. Especially alkoxy-terminated polysiloxanes can lose the ability to cure after storage in a cartridge and show decreased hardness under curing conditions. It may, therefore be useful to add compounds of the formula (8), which can extend storage time or ability to cure over months:

O═P(OR⁶)_{3-c}(OH)_{c} (8)

whereby c is as defined above; and R⁶ is selected from the group of linear or branched and optionally substituted C₁-C₃₀ alkyl groups, linear or branched C₅-C₁₄ cycloalkyl groups, C₆-C₁₄ aryl groups, C₆-C₃₁ alkylaryl groups, linear or branched C₂-C₃₀ alkenyl groups or linear or branched C₁-C₃₀ alkoxyalkyl groups, C₄-C₃₀₀ polyalkenylene oxide groups (polyethers), such as Marlophor® N5 acid, triorganylsilyl- and diorganyl (C₁-C₈)-alkoxysilyl groups. The phosphates can include also mixtures of primary and secondary esters. Non-limiting examples of suitable phosphonates include 1-hydroxyethane-(1,1-diphosphonic acid) (HEDP), aminotris(methylene phosphonic acid) (ATMP), diethylenetriaminepenta(methylene phosphonic acid) (DTPMP), 1,2-diaminoethane-tetra(methylene phosphonic acid) (EDTMP), and phosphonobutanetricarboxylic acid (PBTC).

In another embodiment, a compound of the formula O═P(OR⁷)_{3-g}(OH)_{g} may be present or added where g is 1 or 2, and R⁷ is defined as R⁶ or di- or multivalent hydrocarbons with one or more amino group.

Another type are phosphonic acid compounds of the formula R⁶P(O)(OH)₂ such as alkyl phosphonic acids preferably hexyl or octyl phosphonic acid.

In one embodiment, the acidic compound may be chosen from a mono ester of phosphoric acid of the formula (R⁸O)PO(OH)₂; a phosphonic acid of the formula R⁸P(O)(OH)₂; or a monoester of phosphorous acid of the formula (R⁸O)P(OH)₂ where R⁸ is a C₁-C₁₈ alkyl, a C₂-C₂₀ alkoxyalkyl, phenyl, a C₇-C₁₂ alkylaryl, a C₂-C₄ polyalkylene oxide ester or its mixtures with diesters, etc.

In another embodiment, the acidic compound (F) can be a branched C₄-C₃₀ alkyl carboxylic acids, including C₅-C₁₉ acids with an alpha tertiary carbon, or a combination of two or more thereof. Examples of such suitable compounds include, but are not limited to, Versatic™ Acid, lauric acid, and stearic acid. In one embodiment, the acidic compound may be a mixture comprising branched alkyl carboxylic acids. In one embodiment, the acidic compound is a mixture of mainly tertiary aliphatic Cio carboxylic acids.

Generally, the acidic component (F) is added in a molar ratio of less than or equal to 1 with respect to catalyst (C). In embodiments, the acidic component (F) is added in a molar ratio of (F):(C) of 1:15 to 1:1.

The curable composition may also include auxiliary substances (G) such as plasticizers, pigments, stabilizers, anti-microbial agents, fungicides, biocides, and/or solvents. Preferred plastizers for reactive polyorganosiloxanes (A) are selected from the group of polyorganosiloxanes having chain lengths of 10 to 300 siloxy units. Preferred are trimethylsilyl terminated polydimethylsiloxanes having a viscosity of 100 to 1000 mPa·s at 25° C. The choice of optional solvents (dispersion media or extenders) may have a role in assuring uniform dispersion of the catalyst, thereby altering curing speed. Such solvents include polar and non-polar solvents such as toluene, hexane, chloroform, methanol, ethanol, isopropyl alcohol, acetone, methylethyl ketone, dimethylformamide (DMF), dimethyl sulfoxide (DMSO), N-methylpyrrolidinone (NMP), and propylene carbonate. Water can be an additional component (G) to accelerate fast curing 2-part compositions RTV-2, whereby the water can be in one part of the 2 compositions. Particularly suitable non-polar solvents include, but are not limited to, toluene, hexane, and the like if the solvents should evaporate after cure and application. In another embodiment, the solvents include high-boiling hydrocarbons such as alkylbenzenes, phthalic acid esters, arylsulfonic acid esters, trialkyl- or triarylphosphate esters, which have a low vapor pressure and can extend the volume providing lower costs. Examples cited by reference may be those of U.S. Pat. No. 6,599,633; U.S. Pat. No. 4,312,801. The solvent can be present in an amount of from about 20 to about 99 wt. % of the catalyst composition.

Applicants have found that the metal-complexes based on yttrium, gallium, scandium, and/or tantalum can function as a cure accelerator and/or condensation catalyst and provide a curable composition that yields a cured polymer exhibiting a tack-free time, hardness, adhesion, and/or cure time comparable or even superior to compositions made using tin catalysts.

In one embodiment, a composition in accordance with the present invention comprises: 100 pt. wt. polymer component (A); about 0.1 to about 10 pt. wt. crosslinker component (B); and about 0.01 to about 7 pt. wt. catalyst (C). In one embodiment, the composition further comprises from about 0.1 to about 5, in one embodiment 0.15 to 1 pt. wt., of an adhesion promoter component (D); about 0 to about 300 pt. wt. filler component (E); about 0.01 to about 7 pt. wt. of acidic compound (F); optionally 0 to about 15 pt. wt. component (G), where the pt. wt. of components (B) (G) are each based on 100 parts of the polymer component (A). In one embodiment, the composition comprises the component (F) in an amount of from about 0.01 to about 1 pt. wt. per 100 pt. wt. of component (A). In still another embodiment, the composition comprises the catalyst (C) in an amount of from about 0.1 to about 0.8 wt. pt. per 100 wt. pt of component (A).

It will be appreciated that the curable compositions may be provided as either a one-part composition or a two-part composition. A one-part composition refers to a composition comprising a mixture of the various components described above. A two-part composition may comprise a first portion and a second portion that are separately stored and subsequently mixed together just prior to application for curing. In one embodiment, a two-part composition comprises a first portion (P1) comprising a polymer component (A) and a crosslinker component (B), and a second portion (P2) comprising the catalyst component (C) comprising the metal-containing compound. The first and second portions may include other components (F) and/or (G) as may be desired for a particular purpose or intended use. For example, in one embodiment, the first portion (P1) may optionally comprise an adhesion promoter (D) and/or a filler (E), and the second portion (P2) may optionally comprise auxiliary substances (G), a cure rate modifying component (F), and water (G).

In one embodiment, a two-part composition comprises (i) a first portion comprising the polymer component (A), optionally the filler component (E), and optionally the acidic compound (F); and (ii) a second portion comprising the crosslinker (B), the catalyst component (C), the adhesive promoter (D), and the acidic compound (F), where portions (i) and (ii) are stored separately until applied for curing by mixing of the components (i) and (ii).

An exemplary two-part composition comprises: a first portion (i) comprising 100 pt. wt. of component (A), and 0 to 70 pt. wt. of component (E); and a second portion (ii) comprising 0.1 to 5 pt. wt. of at least one crosslinker (B); 0.05 to 4 pt. wt. of a catalyst (C); 0.1 to 2 pt. wt. of an adhesion promoter (D); and 0.02 to 1 pt. wt. component (F).

The curable compositions may be used in a wide range of applications including as materials for sealing, mold making, glazing, prototyping; as adhesives; as coatings in sanitary rooms; as joint seal between different materials, e.g., sealants between ceramic or mineral surfaces and thermoplastics; as paper release; as impregnation materials; and the like. A curable composition in accordance with the present invention comprising a metal-containing compound as an catalyst may be suitable for a wide variety of applications such as, for example, a general purpose and industrial sealant, potting compound, caulk, adhesive or coating for construction use, insulated glass, structural glazing, where glass sheets are fixed and sealed in metal frame; caulks, adhesives for metal plates, car bodies, vehicles, electronic devices, and the like. Furthermore, the present composition may be used either as a one-part RTV-1 or as a two-part RTV-2 formulation that can adhere onto broad variety of metal, mineral, ceramic, rubber, or plastic surfaces.

Curable compositions metal-containing compounds may be further understood with reference to the following Examples.

### Examples

### General Experimental Procedure

99.66 grams of (silanol-stopped PDMS, silica filler, and/or calcium carbonate low molecular weight PDMS)/(silanol-stopped PDMS, silica filler, and low molecular weight PDMS) is added to a mixture of 1 gram of ethyl polysilicate (EPS), 0.5 grams of adhesion promoter, and a catalyst (0.05 to 0.4 grams), and the resulting mixture is mixed using a Hauschild mixer for 1.5 minutes. The mixed formulation is poured into a Teflon mold (length x breadth x depth of about 10 cm×10 cm×1 cm) and placed inside a fume hood. The surface curing (TFT) and bulk curing is monitored as a function of time (maximum of 3 days). The Comparative Example utilizes dibutyltin-dilaurate as the catalyst

### Measurement of Surface Curing (TFT) and Bulk Curing

The surface cure is denoted by tack free time (TFT). In a typical TFT measurement, a stainless steel weight (weighing about 10 grams) is placed on the surface of the formulation that is spread on the Teflon mold to infer the tackiness of the surface based on whether any material is adhered to the surface of the weight. TFT is defined as the time taken for getting a non-tacky surface. Bulk curing is the time taken for complete curing of formulation throughout the thickness (i.e. top to bottom) and it is monitored as a function of time (visual inspection) as well as shore A hardness measurement as a function of time 1 day, 2 days, and 3 days. Table 1 compares the properties of TFT and bulk cure properties of metal complexes along with aminosilane which acts as both adhesion promoter as well as synergists.

### Measurement of the Storage Stability

For aging studies the pre-mixed mixture containing ethyl polysilicate (EPS), aminosilanes, catalyst, cure accelerator, and storage stabilizer are kept in an oven for (1) 4 hours at 50° C., or (2) 5 days at 70° C., after which specified period the mixture is removed from the oven and allowed to cool to room temperature. The mixture is further mixed with a mixture of PDMS and silica based component using Hauschild mixer for 1.5 minutes. The mixed formulation is poured into a Teflon mold (length×breadth×depth of about 10 cm×10 cm×1 cm) and placed inside a fume hood. The surface curing (TFT) and bulk curing is monitored as a function of time (maximum of 3 days) and Shore A hardness in order to determine to what extent the compositions maintain performance after storage under accelerated heat ageing conditions. An increased temperature for the storage test should simulate the storage effect at room temperature (25° C., 50% relative humidity) over longer times in a kind of time lapse.

TABLE 1

| | Comp Ex-1 | Example 1 | Example 2 | Example 3 |
|---|---|---|---|---|
| Mixture of OH-endcapped PDMS | 50 | 50 | 50 | 50 |
| trimethylsilyl terminated siloxane | 20 | 20 | 20 | 20 |
| Silica | 18 | 18 | 18 | 18 |
| CaCo3 | 12 | 12 | 12 | 12 |

Component B

| | | | | |
|---|---|---|---|---|
| Ethyl polysilicate | 1 | 1 | 1 | 1 |
| Bis(3-propyltrimethoxysilyl) amine | 0.8 | 0.8 | 0.8 | 0.8 |
| N-β-(Aminoethyl)-v-aminopropyl- | 0.6 | 0.6 | 0.6 | 0.6 |
| trimethoxysilane | | | | |
| Dibutyltin-dilaurate (DBTDL) | 0.1 | | | |
| Galium triflate (Ga(III)Tf) | | 0.1 | | |
| Yttrium neodecanoate (Y(III)ND) | | | 0.05 | 0.2 |
| Tack-free Time (min) -Comp B aged 4 hours | 20 | 18 | 14 | 11 |
| at 50° C. | | | | |
| Shore-A Hardness (top/bottom)-Comp B | 34/27 | 33/20 | 37/36 | 37/37 |
| aged 4 hours at 50° C. (tested after 3 days) | | | | |
| Tack-free Time (min) -Comp B aged 5 hours | 25 | 22 | 22 | 17 |
| at 70° C. | | | | |
| Shore-A Hardness (top/bottom)-Comp B | 33/26 | 36/22 | 38/36 | 38/37 |
| aged 4 hours at 70° C. (tested after 3 days) | | | | |

Adhesion test to ten different substrates

| | | | | |
|---|---|---|---|---|
| Adhesion-Comp B aged 4 hours at 50° C. | ∘∘∘ | ∘∘x | ∘∘Δ∘ | ∘∘Δ∘ |
| (tested after 3 days) | | | | |
| Adhesion-Comp B aged 5 days at 70° C. | ∘∘∘ | ∘∘∘ | ∘∘∘ | ∘∘∘ |
| (tested after 3 days) | | | | |

Test sample thickness = 10 mm
∘ = cohesive failure
x = adhesive failure
Δ∘ = ~80 cohesive failure

The Comparative Example and the Working Examples 1-3 show the effect of gallium triflate and yttrium neodecanoate in combination with an aminosilane to provide the faster TFT. The tin catalyst is replaced by combinations with similar loading as shown in Working Examples 1-3. The above results demonstrate the synergism between yttrium and gallium complexes with amino silanes.

Embodiments of the invention have been described above and modifications and alterations may occur to others upon the reading and understanding of this specification. The claims as follows are intended to include all modifications and alterations insofar as they come within the scope of the claims or the equivalent thereof.

1. A composition for forming a curable polymer composition comprising:
(A) a polymer having at least a reactive silyl group;
(B) a crosslinker; a chain extender; an extender; or a combination of two or more thereof
(C) a catalyst comprising a metal-containing compound, wherein the metal is chosen from yttrium, gallium, scandium, and/or tantalum;
(D) an adhesion promoter;
(E) optionally a filler; and
(F) optionally a cure accelerator.

2. The composition of claim 1, wherein the metal-containing compound comprises a compound of the formula (6):
M^{III}L_{3-c}A_{c} (6)
wherein M is a metal chosen from yttrium, gallium, scandium, and/or tantalum; L is a chelating ligand; A is an anion; and c is 0 to 3 or an integer.

3. The composition of claim 2, wherein L is chosen from a diketonate, a diamine, a triamine, an aminoacetate, a nitriloacteate, a bipyridine, a glyoxime, a carboxylate, an acetate, or a combination of two or more thereof.

4. The composition of claim 2, wherein L is chosen from a monocarboxylic acid or a carboxylic acid containing at least two carbon atoms.

5. The composition of claim 2, wherein L is chosen from a carboxylic acid of the formula R⁹COO⁻, and R⁹ is a linear or branched C₁-C₃₀ alkyl group, a C₆-C₁₀ cyclic group, or a C₆-C₁₀ aromatic group.

6. The composition of claim 2, wherein L is chosen from a monocarboxylic aliphatic acid, pentanoic acid, n-octanoic acid, n-nonanoic acid, n-decanoic acid, n-undecanoic acid, neodecanoic acid, a resin acid, abietic acid, naphthenic acid, palmitic acid, stearic acid, oleic acid, linoleic acid, linolenic acid, arachidic acid, behenic acid, benzoic acid, phenylacetic acid, dodecanoic acid, tridecanoic acid, oleic acid, or a combination of two or more.

7. The composition of claim 2, wherein the anion A is chosen from a halide, hydroxide, oxide, peroxide, ozonide, hydrosulfide, alkoxides, alkyl thio, nitride, acetate, amide, carboxylate, cyanide, cyanate, thiocyanate, carbonate, hydrogen carbonate, or a combination of two or more.

8. The composition of claim 2, wherein the anion A is chosen from F⁻, Cr⁻, (I₃)⁻, [ClF₂]⁻, [IF₆]⁻, (ClO)⁻, (ClO₂)⁻, (ClO₃)⁻, (ClO₄)⁻, (OH)⁻, (SH)⁻, (SeH)⁻, (O₂)⁻, (O₃)⁻, (HS₂)⁻, (CH₃O)⁻, (C₂H₅O)⁻, (C₃H₇O)⁻, (CH₃S)⁻, (C₂H₅S)⁻, (C₂H₄CIO)⁻, (C₆H₅O)⁻, (C₆H₅S)⁻, [C₆H₄(NO₂)O]⁻, (HCO₂)⁻, (C₇H₁₅CO₂)⁻, (CH₃CO₂)⁻, (CH₃CH₂CO₂)⁻, (N₃)⁻, (CN)⁻, (NCO)⁻, (NCS)⁻, (NCSe)⁻, (NH₂)⁻, (PH₂)⁻, (ClHN)⁻, (Cl₂N)⁻, (CH₃NH)⁻, (HN═N)″, (H₂N—NH)⁻, (HP═P)⁻, (H₂PO)⁻, (H₂PO₂)⁻, or a combination of two or more.

9. The composition of claim 1, wherein the metal-containing compound comprises a yttrium carboxylate.

10. The composition of claim 1, wherein the metal-containing compound comprises a gallium triflate.

11. The composition of claim 1, comprising from about 0.0001 to 10 parts per weight of catalyst (C) per 100 parts per weight of the polymer (A).

12. The composition of claim 1, comprising from about 0.005 to 0.05 parts per weight of catalyst (C) per 100 parts per weight of the polymer (A).

13. The composition of claim 1, comprising from about 0.01 to 5 parts per weight of catalyst (C) per 100 parts per weight of the polymer (A).

14. The composition of claim 1, comprising from about 0.05 to about 0.4 parts per weight of catalyst (C) per 100 parts per weight of the polymer (A).

15. The composition of claim 1, comprising from about 0.1 to 1 parts per weight of catalyst (C) per 100 parts per weight of the polymer (A).

16. The composition of claim 1, wherein the catalyst (C) is substantially free of tin.

17. The composition of claim 1, wherein the catalyst (C) further comprises a blend of metal catalyst, a salt of a metal catalyst, a carboxylic acid, an alkyl-sulfonic acid, an aryl sulfonic acid, an inorganic acid, an amine, a guanidine, an amidine, an inorganic base, or a combination of two or more thereof.

18. The composition of claim 1, wherein the adhesion promoter compromises an amine-based adhesion promoter.

19. The composition of claim 1, comprising an adhesion promoter component (D) is chosen from an (aminoalkyl)trialkoxysilane, an (aminoalkyl)alkyldialkoxysilane, a bis(trialkoxysilylalkyl)amine, a tris(trialkoxysilylalkyl)amine, a tris(trialkoxysilylalkyl)cyanurate, a tris(trialkoxysilylalkyl)isocyanurate, an (epoxyalkyl)alkyldialkoxysilane, an (epoxyalkyl)trialkoxysilane, or a combination of two or more thereof.

20. The composition of claim 1, wherein the crosslinker or chain extender is chosen from an alkoxysilane, an alkoxysiloxane, an oximosilane, an oximosiloxane, an enoxysilane, an enoxysiloxane, an aminosilane, an aminosiloxane, a carboxysilane, a carboxysiloxane, an alkylamidosilane, an alkylamidosiloxane, an arylamidosilane, an arylamidosiloxane, an alkoxyaminosilane, an alklarylaminosiloxane, an alkoxycarbamatosilane, an alkoxycarbamatosiloxane, and combinations of two or more thereof.

21. The polymer composition of claim 1, wherein the polymer (A) has the formula (1):
[R¹ₐR²₃₋ₐSi—Z—]ₙ—X—Z—SiR¹ₐR²₃₋ₐ (1)
where X is chosen from a polyurethane; a polyester; a polyether; a polycarbonate; a polyolefin; a polyesterether; and a polyorganosiloxane having units of R₃SiO_{1/2}, R₂SiO, RSiO_{3/2}, and/or SiO₂; n is 0 to 100; a is 0 to 2; R and R¹ can be identical or different at the same Si-atom and chosen from a C₁-C₁₀ alkyl; a C₁-C₁₀ alkyl substituted with one or more of Cl, F, N, O or S; a phenyl; a C₇-C₁₆ alkylaryl; a C₇-C₁₆ arylalkyl; a C₂-C₄ polyalkylene ether; or a combination of two or more thereof; R² is chosen from OH, C₁-C₈ alkoxy, C₂-C₁₈ alkoxyalkyl, oximoalkyl, enoxyalkyl, aminoalkyl, carboxyalkyl, amidoalkyl, amidoaryl, carbamatoalkyl, or a combination of two or more thereof; and Z is a bond, a divalent unit selected from the group of a C₁-C₈ alkylene, or 0.

22. The polymer composition of claim 1, wherein the polymer component (A) has the formula (3):
R²_{3-c-d}SiR³_{c}R⁴_{d}—[OSiR³R⁴]ₓ—[OSiR³R⁴]_{y}—OSiR³ₑR⁴_{f}R²_{3-e-f} (3)
where x is 0 to 10000; y is 0 to 1000; c, d, and f are independently chosen from 0 to 2; le is chosen from a C₁-C₁₀ alkyl; a C₁-C₁₀ alkyl substituted with one or more of Cl, F, N, O, or S; a phenyl; a C₇-C₁₆ alkylaryl; a C₇-C₁₆ arylalkyl; a C₂-C₄ polyalkylene ether; or a combination of two or more thereof, and other siloxane units may be present in amounts less than 10 mol. % preferably methyl, vinyl, phenyl; R² is chosen from OH, a C₁-C₈ alkoxy, a C₂-C₁₈ alkoxyalkyl, an oximoalkyl, an oximoaryl, an enoxyalkyl, an enoxyaryl, an aminoalkyl, an aminoaryl, a carboxyalkyl, a carboxyaryl, an amidoalkyl, an amidoaryl, a carbamatoalkyl, a carbamatoaryl, or a combination of two or more thereof; and Z is —O—, a bond, or —C₂H₄—; and R³ and R⁴ can be identical or different on the same silicon atom and are chosen from hydrogen; C₁-C₁₀ alkyl; C₁-heteroalkyl, C₃-C₁₂ cycloalkyl; C₂-C₃₀ heterocycloalkyl; C₆-C₁₃ aryl; C₇-C₃₀ alkylaryl; C₇-C₃₀ arylalkyl; C₄-C₁₂ heteroaryl; C₅-C₃₀ heteroarylalkyl; C₅-C₃₀ heteroalkylaryl; C₂-C₁₀₀ polyalkylene ether; or a combination of two or more thereof.

23. The composition of claim 1, wherein the polymer (A) is chosen from silylated polyurethane (SPUR), silylated polyester, silylated polyether, silylated polycarbonate, silylated polyolefins like polyethylene, polypropylene, silylated polyesterether, and combinations of two or more thereof.

24. The composition of claim 1, wherein the crosslinker component (B) is chosen from tetraethylorthosilicate (TEOS); methyltrimethoxysilane (MTMS); methyltriethoxysilane; vinyltrimethoxysilane; vinyltriethoxysilane; methylphenyldimethoxysilane; 3,3,3-trifluoropropyltrimethoxysilane; methyltriacetoxysilane; vinyltriacetoxysilane; ethyltriacetoxysilane; di-butoxy diacetoxysilane; phenyltripropionoxysilane; methyltris(methylethylketoximo)silane; vinyltris(methylethylketoximo)silane; 3,3,3-trifluoropropyltris(methylethylketoximo)silane; methyltris(isopropenoxy)silane; vinyltris(isopropenoxy)silane; ethylpolysilicate; dimethyltetraacetoxydisiloxane; tetra-n-propylorthosilicate; methyldimethoxy(ethylmethylketoximo)silane; methylmethoxybis(ethylmethylketoximo)silane; methyldimethoxy(acetaldoximo)silane; methyldimethoxy(N-methylcarbamato)silane; ethyldimethoxy(N-methylcarbamato)silane; methyldimethoxyisopropenoxysilane; trimethoxyisopropenoxysilane; methyltriisopropenoxysilane; methyldimethoxy(but-2-en-2-oxy)silane; methyldimethoxy (1-phenyl ethenoxy)silane; methyldimethoxy-2-(1-carboethoxypropenoxy)silane; methylmethoxydi(N-methylamino)silane; vinyldimethoxy(methylamino)silane; tetra-N,N-di ethyl aminosilane; methyldimethoxy(methylamino)silane; methyltri(cyclohexylamino)silane; methyldimethoxy(ethylamino)silane; dimethyldi(N,N-dimethylamino)silane; methyldimethoxy(isopropylamino)silane; dimethyldi(N,N-diethylamino)silane; ethyldimethoxy(N-ethylpropionamido)silane; methyldimethoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(caprolactamo)silane; trimethoxy(N-methylacetamido)silane; methyldimethoxy(ethylacetimidato)silane; methyldimethoxy(propylacetimidato)silane; methyldimethoxy(N,N′,N′-trimethylureido)silane; methyldimethoxy(N-allyl-N′,N′-dimethylureido)silane; methyldimethoxy(N-phenyl-N′,N′-dimethylureido)silane; methyldimethoxyisocyanatosilane; dimethoxydiisocyanatosilane; methyldimethoxyisothiocyanatosilane; methylmethoxydiisothiocyanatosilane, the condensates thereof, or a combination of two or more thereof.

25. The composition of claim 1, wherein the composition is a two-part composition comprising: (i) a first portion comprising the polymer component (A), optionally the filler component (E), and optionally the acidic compound (F); and (ii) a second portion comprising the crosslinker (B), the adhesion promoter (D), the catalyst (C), and the acidic compound (F), whereby (i) and (ii) are stored separately until applied for curing by mixing of the components (i) and (ii).

26. The composition of claim 1 comprising a chain externder chosen from an organo-functional siloxane, an alkyl stopped siloxone, a nonreactive organic polymer, or a combination of two or more thereof.

27. The composition of claim 1 comprising from about 0.0001 to about 20 parts per weight of the chain extender per 100 parts per weight of the polymer (A).

28. A cured polymer formed from the composition or method of claim 1.

29. The cured polymer of claim 28, in the form of an elastomeric seal, a duromeric seal, an adhesive, a coating, an encapsulant, a shaped article, a mold, or an impression material.

30. A curable composition comprising:
a compound having at least one hydrosilyl group; and
a condensation accelerator comprising a metal-containing compound, wherein the metal is chosen from yttrium, gallium, scandium, and/or tantalum.

31. The composition of claim 30, wherein the metal-containing compound comprises a compound of the formula (6):
M^{III}L_{3-c}A_{c} (6)
wherein M is a metal chosen from yttrium, gallium, scandium, and/or tantalum; L is a chelating ligand; A is an anion; and c is 0 to 3 or an integer.

32. The composition of claim 30, wherein L is chosen from a diketonate, a diamine, a triamine, an aminoacetate, a nitriloacteate, a bipyridine, a glyoxime, a carboxylate, an acetate, or a combination of two or more thereof.

33. The composition of claim 30, wherein L is chosen from a monocarboxylic acid or a carboxylic acid containing at least two carbon atoms.

34. The composition of claim 30, wherein L is chosen from a carboxylic acid of the formula R⁹COO⁻, and R⁹ is a linear or branched C₁-C₃₀ alkyl group, a C₆-C₁₀ cyclic group, or a C₆-C₁₀ aromatic group.

35. The composition of composition of claim 30, wherein L is chosen from a monocarboxylic aliphatic acid, pentanoic acid, n-octanoic acid, n-nonanoic acid, n-decanoic acid, n-undecanoic acid, neodecanoic acid, a resin acid, abietic acid, naphthenic acid, palmitic acid, stearic acid, oleic acid, linoleic acid, linolenic acid, arachidic acid, behenic acid, benzoic acid, phenylacetic acid, dodecanoic acid, tridecanoic acid, oleic acid, or a combination of two or more.

36. The composition of claim 31, wherein the anion A is chosen from a halide, hydroxide, oxide, peroxide, ozonide, hydrosulfide, alkoxides, alkyl thio, nitride, acetate, amide, carboxylate, cyanide, cyanate, thiocyanate, carbonate, hydrogen carbonate, or a combination of two or more.

37. The composition of claim 31, wherein the anion A is chosen from F, Cl⁻, (I₃)⁻, [ClF₂]⁻, [IF₆]⁻, (ClO)⁻, (ClO₂)⁻, (ClO₃)⁻, (ClO₄)⁻, (OH)⁻, (SH)⁻, (SeH)⁻, (O₂)⁻, (O₃)⁻, (HS₂)⁻, (CH₃O)⁻, (C₂H₅O)⁻, (C₃H₇O)⁻, (CH₃S)⁻, (C₂H₅S)⁻, (C₂H₄CIO)⁻, (C₆H₅O)⁻, (C₆H₅S)⁻, [C₆H₄(NO₂)O]⁻, (HCO₂)⁻, (C₇H₁₅CO₂)⁻, (CH₃CO₂)⁻, (CH₃CH₂CO₂)⁻, (N₃)⁻, (CN)⁻, (NCO)⁻, (NCS)⁻, (NCSe)⁻, (NH₂)⁻, (PH₂)⁻, (ClHN)⁻, (Cl₂N)⁻, (CH₃NH)⁻, (HN═N)″, (H₂N—NH)⁻, (HP═P)⁻, (H₂PO)⁻, (H₂PO₂)⁻, or a combination of two or more.

38. The composition of claim 30, wherein the metal-containing compound comprises a yttrium carboxylate.

39. The composition of claim 30, wherein the metal-containing compound comprises a gallium triflate.

40. The composition of claim 30, comprising from about 0.0001 to 10 parts per weight of the condensation accelerator per 100 parts per weight of the compound having at least on hydrosilyl group.

41. The composition of claim 30 comprising from about 0.0001 to about 20 parts per weight of a chain extender and/or an extender per 100 parts per weight of the compound having at least one hydrosilyl group.
